(19) United States
(12) Patent Application Publication
(10) Pub. No.: US 2024/0329775 A1
(43) Pub. Date: Oct. 3, 2024

(54) MODIFICATION OF DISPLAY BEHAVIOR IN NON-ACTIVE WINDOWS

(71) Applicant: Lenovo (Singapore) Pte. Ltd., Singapore (SG)

(72) Inventors: John Weldon Nicholson, Cary, NC (US); Daryl C. Cromer, Raleigh, NC (US); Howard J. Locker, Cary, NC (US)

(21) Appl. No.: 18/194,219

(22) Filed: Mar. 31, 2023

(51) Int. Cl. G06F 3/041; G09G 3/20

(52) U.S. Cl. CPC G06F 3/041661; G09G 3/2007; G09G 2320/0686; G09G 2330/021

(57) ABSTRACT

A display device includes a display panel for displaying data within windows formed of pixels. The display device includes control circuitry to identify a coordinate set and an area corresponding to an active window within the pixels. The control circuitry provides instructions to the display panel to modify display behavior of pixels that are not within the active window.

### TECHNICAL FIELD

Embodiments described herein generally relate to electronic device displays, and in an embodiment, but not by way of limitation, display behavior when multiple windows are displayed.

### BACKGROUND

Many users of computer devices keep several display windows open simultaneously so that multiple tasks can be performed. At the same time, users expect longer operating time, placing greater burdens and demands on device battery systems. Battery power is drained in driving the display for extended periods of time, and thus it becomes more and more difficult to keep up with the pressing need of longer operating time for modern electronic devices with greater and more functionality. Rather than enhancing battery power, reducing power consumption is becoming an alternative and more feasible way to reach that goal.

Battery usage can be reduced by selectively dimming or lowering the refresh rate of different portions of the display. However, some user applications or other software running on computing devices may not support selective display parameters. Furthermore, power may be consumed by graphics drivers or other components in implementing a selective dimming strategy, negating any power benefit that could be achieved. For these and other reasons, there is a general need to modify display parameters in a way that does not rely on application or operating system support.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram of a display device for displaying multiple windows.

FIG. 2 is a flowchart of a method for modifying display behavior.

FIG. 3 is a block diagram of a computer architecture upon which one or more of the embodiments disclosed herein can execute.

### DETAILED DESCRIPTION

Computer users often prefer to keep several windows open on their displays to easily switch between multiple tasks. Display devices for displaying these windows can consume significant power, particularly when brightness settings are high. Screen refresh rate also contributes to battery consumption. However, from a user viewpoint only the active (or focus) window needs to be at high brightness/high refresh rate, and accordingly large amounts of power may be wasted in keeping all open windows at the same brightness and refresh rate.

Some available solutions address this concern by using a host operating system, graphics driver, etc. to selectively dim and lower the refresh rate of portions of the screen. However, not all device operating systems, graphics drivers, and user applications support this function. Accordingly, some devices will not be able to dim or otherwise modify display windows and, even when devices can selectively dim windows, some applications will not permit associated windows to be dimmed. Finally, implementing selective dimming can consume power, thereby negating any power savings achieved with selective dimming.

Systems according to embodiments of the present disclosure address these and other concerns by identifying or detecting the active window within the display itself, without a dependency on the device operating system, graphics drivers, or applications. The display device can dim other (non-active) windows, lower the refresh rate, or perform other power-saving actions.

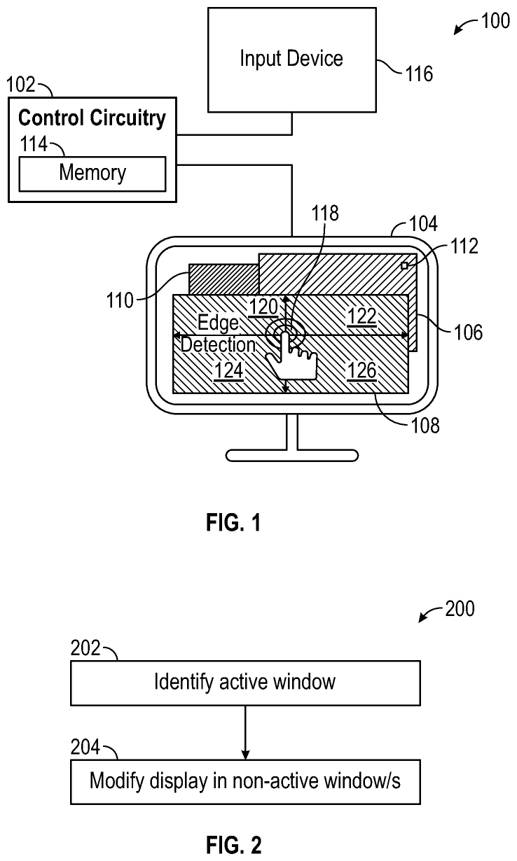

FIG. 1 is a high-level diagram of a display device 100 for displaying multiple windows. The display device 100 can include control circuitry 102, which controls a signal to a display panel 104. The display panel 104 can a display panel configured to display data within windows 106, 108 and 110. The windows 106, 108, and 110 can be formed of a plurality of pixels 112. One pixel 112 is specifically pointed out for purposes of clarity only, and the windows 106, 108, 110 will be formed of a plurality of pixels depending on the resolution of the display panel 104.

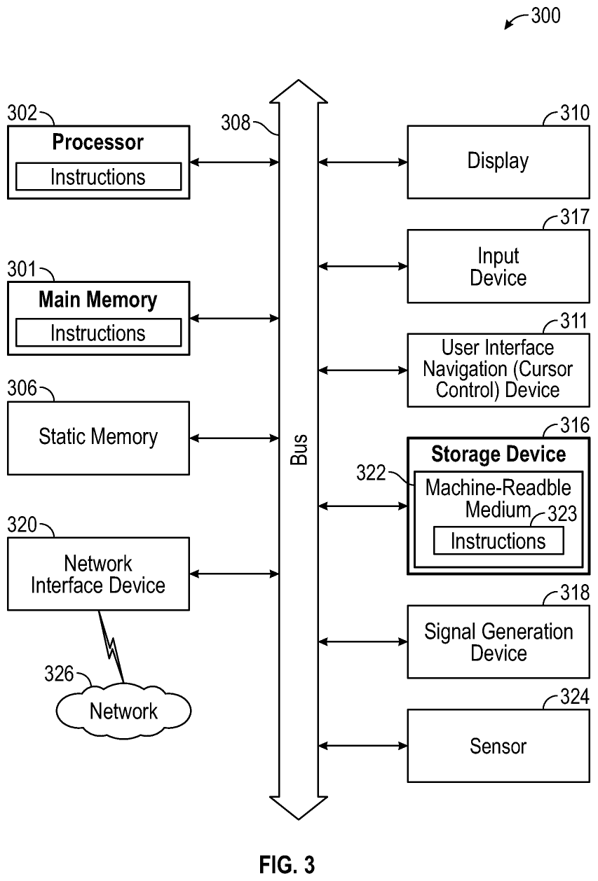

The control circuitry 102 can identify a coordinate set and an area corresponding to an active window 108 within the pixels. The control circuitry 102 can provide an instruction to the display panel 104 to modify a display behavior of pixels of the plurality of pixels that are outside the active window 108 (e.g., pixels within non-active windows 106 and 110 or pixels that are not within any window). The display behavior controlled by the control circuitry 102 can include one or more of reducing a brightness level of pixels of the plurality of pixels that are outside the active window 108 or reducing a refresh rate of pixels of the plurality of pixels that are outside the active window 108. The control circuitry 102 can provide control of these and other parameters regardless of device operating system, graphics drivers, and/or applications that can operate on other components of a device that includes the display panel 104 (including components described in more detail with reference to FIG. 3).

The control circuitry 102 can identify the active window 108 based on position information provided by a touch screen or by a stylus or pen. The sensing of a stylus/pen is built into the display device 100 in much the same way that the finger-touch sensing is built into the display device 100.

In some embodiments, a mouse or cursor (e.g., an X-Y position indicating device or other input device 116) can be used to detect position information of the active window 108. In at least these embodiments, the control circuitry 102 can include memory 116 to store video frame data (or any other data related to operating systems, applications, etc. running on associated processors or circuitry of a user device). The control circuitry 102 can detect a position of the active window 108 based on analysis of the video frame data to detect position information provided by the X-Y position indicating device or other input device 116. In some examples, the input device 116 can provide universal serial bus (USB) data or other protocol data (which can include position data or similar data) to the control circuitry 102. The control circuitry 102 can use the USB data or other protocol data of the input device 116 to detect position or area of the active window 108. When an input device 116 (e.g., mouse cursor) is over (e.g., hovering over) a window that is not the active window 108, the window under the mouse cursor can be shown at full brightness and refresh rate, even if that window is not yet active.

The display device 100 can include an interface to couple the display device 100 to a host, as shown in more detail below in FIG. 3 (e.g., display 310, interface 308). In some embodiments, the host can provide identification information to identify the active window to the control circuitry. In some embodiments, the operating system can provide an indication to the control circuitry 102 to define an active region, obviating the need for the edge detection/automatic mode described above. Mouse or cursor position or selection can also be used to directly define the active window without edge detection by the control circuitry 102.

At an initial time that a user touches the screen (as depicted in FIG. 1 by position of a user finger although embodiments are not limited to touch screens as described above) the control circuitry 102 can transmit the touch location to the user device operating system (using e.g., bus 308 as described later herein). The OS can then identify, note, or mark the touched window as the active window (e.g., window 108 (FIG. 1)). The control circuitry 102 can determine the position of the active window 108 by analyzing the video frame buffer stored in memory 114. The analysis can include edge detection within a threshold proximity of the touch location 118 to determine the left edge 120, the right edge 122, the top edge 124 and the bottom edge 126 of the active window 108. The edge can be detected based upon detecting pixel color changes within the active window 108. In some examples, when the control circuitry 102 is notified of the active window by the host, the control circuitry 102 may not perform edge detection as the active window has already been determined. In some examples, when windows are overlapping (as depicted in FIG. 1) and the host has not notified the control circuitry 102 of an active window, changing the active window will typically cause a partial/non-rectangular window to be moved to the foreground and become rectangular. In another case like side-by-side windows without overlap, the control circuitry 102 can identify which window is active based on the touch location without waiting for the OS to change any parameters or provide any notifications.

Algorithms for edge detection can include Sobel operator algorithms, which can perform a two-dimensional spatial gradient measurement to detect regions that may correspond to an edge. Other edge detection algorithms can include Laplacian of Gaussian filters, which use Laplacian filters to find areas of rapid change in images. A Gaussian filter may be applied to smooth the image before Laplacian filtering. However, embodiments are not limited to these edge detection algorithms or methods.

Once the active window 108 location is determined the control circuitry 102 can dim and lower the refresh rate for all pixels not in the active window 108. The active window 108 can have full or enhanced brightness and refresh rate, wherein a full refresh rate is on the order of about 60-240 hertz. The non-active windows 106 and 110 can have a refresh rate on the order of about 1-2 hertz.

The control circuitry 102 can monitor interaction with the display panel 104 to detect changes to the identified active window. For example, other windows 110, 106 can become the active window when the user terminates interaction with an application associated with active window 108. Other active windows can furthermore be detected through user interaction. For example, new or subsequent touch locations can be transmitted to the operating system and, if such subsequent finger touch is outside of the active window 108 the operating system/graphics driver can change the active window to match the finger touch. In addition, the control circuitry 102 can determine if the finger touch is outside of the current active window 108 and, if so, the control circuitry 102 can perform edge detection in a manner similar to that described above to determine the location of the new active window. Upon determining the location of the new active window, the control circuitry 102 can dim and lower the refresh rate of all pixels outside of the new active window (e.g., window 110 or window 106, or a newly-opened window not shown in FIG. 1).

FIG. 2 is a flowchart of a method 200 for modifying display behavior. The method can be performed by the control circuitry 102, memory 114 or any other component of FIG. 1 or FIG. 3. Method 200 can begin with operation 202 by the control circuitry 102 identifying an active window. As described earlier herein, identification of the active window can include identification based on position of a touch or other interaction with a display panel 104 and can include edge detection to determine parameters of the active window (e.g., coordinates, area, etc.).

Method 200 can continue with operation 204 with the control circuitry 102 providing control signals to modify display of any of the windows. In particular, as described earlier herein, modification can include one or more of reducing a brightness level of pixels that are outside the active window or reducing a refresh rate of pixels of that are outside the active window.

FIG. 3 is a block diagram illustrating a computing and communications platform 300 in the example form of a general-purpose machine on which some or all the operations of FIGS. 1 and 2 may be carried out according to various embodiments. In certain embodiments, programming of the computing platform 300 according to one or more particular algorithms produces a special-purpose machine upon execution of that programming. In a networked deployment, the computing platform 300 may operate in the capacity of either a server or a client machine in server-client network environments, or it may act as a peer machine in peer-to-peer (or distributed) network environments.

Example computing platform 300 includes at least one processor 302 (e.g., a central processing unit (CPU), a graphics processing unit (GPU) or both, processor cores, compute nodes, etc.), a main memory 301 and a static memory 306, which communicate with each other via a link 308 (e.g., bus). The computing platform 300 may further include a video display unit 310, input devices 317 (e.g., a keyboard, camera, microphone), and a user interface (UI) navigation device 311 (e.g., mouse, touchscreen). The computing platform 300 may additionally include a storage device 316 (e.g., a drive unit), a signal generation device 318 (e.g., a speaker), a sensor 324, and a network interface device 320 coupled to a network 326.

The storage device 316 includes a non-transitory machine-readable medium 322 on which is stored one or more sets of data structures and instructions 323 (e.g., software) embodying or utilized by any one or more of the methodologies or functions described herein. The instructions 323 may also reside, completely or at least partially, within the main memory 301, static memory 306, and/or within the processor 302 during execution thereof by the computing platform 300, with the main memory 301, static memory 306, and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions 323. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B.” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first.” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### Examples

Example 1 is a display device comprising: a display panel configured to display data within windows formed of a plurality of pixels; and control circuitry coupled to the display panel, the control circuitry configured to: identify a coordinate set and an area corresponding to an active window within the plurality of pixels; and provide an instruction to the display panel to modify a display behavior of pixels of the plurality of pixels that are outside the active window.

In Example 2, the subject matter of Example 1 can optionally include wherein the display behavior includes one or more of reducing a brightness level of pixels of the plurality of pixels that are outside the active window or reducing a refresh rate of pixels of the plurality of pixels that are outside the active window.

In Example 3, the subject matter of any of Examples 1-2 can optionally include wherein the display panel comprises a touch sensor and wherein the control circuitry is configured to identify the active window based on detecting a touch on the touch sensor.

In Example 4, the subject matter of any of Examples 1-3 can optionally include wherein the control circuitry is configured to identify the active window based on position information provided by an X-Y position indicating device.

In Example 5, the subject matter of Example 4 can optionally include memory to store video frame data, and wherein the control circuitry is configured to detect a position of the active window based on analysis of the video frame data to detect position information provided by the X-Y position indicating device.

In Example 6, the subject matter of any of Examples 1-5 can optionally include an interface to couple the display device to a host, and wherein the host is configured to provide identification information to identify the active window to the control circuitry.

In Example 7, the subject matter of Example 6 can optionally include wherein to identify the active window the control circuitry is configured to perform edge detection within a threshold proximity of an initial coordinate position indicated for the active window.

In Example 8, the subject matter of Example 7 can optionally include wherein the identification includes detecting pixel color changes within the threshold proximity.

In Example 9, the subject matter of any of Examples 1-8 can optionally include wherein the control circuitry is further configured to monitor interaction with the display panel to detect changes to an active window.

Example 10 is a machine-readable medium for storing instructions that, when implemented on control circuitry of a display device that displays a plurality of pixels, cause the control circuitry to perform operations including any operations of Examples 1-9.

Example 11 is a system comprising means for performing any of Examples 1-9.

1. A display device comprising:
a display panel configured to display data within windows formed of a plurality of pixels; and
control circuitry coupled to the display panel, the control circuitry configured to:
identify a coordinate set and an area corresponding to an active window within the plurality of pixels by performing edge detection within a threshold proximity of an initial coordinate position indicated for the active window through a user selection indication; and
provide an instruction to the display panel to modify a display behavior of pixels of the plurality of pixels that are outside the active window.

2. The display device of claim 1, wherein the display behavior includes one or more of reducing a brightness level of pixels of the plurality of pixels that are outside the active window or reducing a refresh rate of pixels of the plurality of pixels that are outside the active window.

3. The display device of claim 1, wherein the display panel comprises a touch sensor and wherein the control circuitry is configured to identify the active window based on detecting a touch on the touch sensor.

4. The display device of claim 1, wherein the control circuitry is configured to identify the active window based on position information provided by an X-Y position indicating device.

5. The display device of claim 4, further comprising memory to store video frame data, and wherein the control circuitry is configured to detect a position of the active window based on analysis of the video frame data to detect position information provided by the X-Y position indicating device.

6. The display device of claim 1, further including an interface to couple the display device to a host, and wherein the host is configured to provide identification information to identify the active window to the control circuitry.

7. (canceled)

8. The display device of claim 1, wherein the identification includes detecting pixel color changes within the threshold proximity.

9. The display device of claim 1, wherein the control circuitry is further configured to monitor interaction with the display panel to detect changes to an active window.

10. A non-transitory machine-readable medium for storing instructions that, when implemented on control circuitry of a display device that displays a plurality of pixels, cause the control circuitry to perform operations including:
identifying a coordinate set and an area corresponding to an active window within the plurality of pixels by performing edge detection within a threshold proximity of an initial coordinate position indicated for the active window through a user selection indication; and
providing an instruction to a display panel to modify a display behavior of pixels of the plurality of pixels that are outside the active window.

11. The non-transitory machine-readable medium of claim 10, wherein the display behavior includes one or more of reducing a brightness level of pixels of the plurality of pixels that are outside the active window or reducing a refresh rate of pixels of the plurality of pixels that are outside the active window.

12. The non-transitory machine-readable medium of claim 10, wherein identifying the active window comprises at least one of detecting a touch on a touch screen and detecting position information provided by an X-Y position indicating device.

13. The non-transitory machine-readable medium of claim 10, further comprising:
receiving identification information to identify the active window from a host system over an interface.

14. The non-transitory machine-readable medium of claim 13, further comprising:
detecting a position of the active window based on analysis of video frame data received over the interface.

15. A system comprising:
host circuitry configured to execute instructions of an operating system and at least one user application; and
a display coupled to the host circuitry, the display comprising:
a display panel configured to display data within windows formed of a plurality of pixels; and
control circuitry configured to
identify a coordinate set and an area corresponding to an active window within the pixels by performing edge detection within a threshold proximity of an initial coordinate position indicated for the active window through a user selection indication; and
provide an instruction to the display panel to modify a display behavior of pixels of the plurality of pixels that are outside the active window.

16. The system of claim 15, wherein the display behavior includes one or more of reducing a brightness level of pixels of the plurality of pixels that are outside the active window or reducing a refresh rate of pixels of the plurality of pixels that are outside the active window.

17. The system of claim 15, wherein the display panel comprises a touch screen and wherein the control circuitry is configured to identify the active window based on detecting a touch on the touch screen.

18. The system of claim 15, wherein the windows include at least one portion or set of pixels not related to a user application.

19. The system of claim 15, wherein the host circuitry is configured to provide identification information to identify the active window to the control circuitry.

20. The system of claim 15, further comprising memory to store video frame data, and wherein the control circuitry is configured to detect a position of the active window based on analysis of the video frame data.
